(19) United States
(12) Patent Application Publication
(10) Pub. No.: US 2010/0004859 A1
(43) Pub. Date: Jan. 7, 2010

(54) Method for display route information for a navigation system

(76) Inventor: Lothar-Frank Smirnov, Stuttgart (DE)

Correspondence Address: KENYON & KENYON LLP, ONE BROADWAY, NEW YORK, NY, 10004, US

(21) Appl. No.: 12/308,233

(22) PCT Filed: Sep. 17, 2007
(86) PCT No.: PCT/EP2007/059749

§ 371 Date: May 13, 2009

(30) Foreign Application Priority Data
Nov. 17, 2006 (DE) 10 2006 054 326.2

(51) Int. Cl. G01C 21/36

(52) U.S. Cl. 701/209; 701/208

(57) ABSTRACT

In a method for depicting route information for a navigation system, a graphical depiction of a digitized map is displayed on a display, and the already-traveled segment of a travel route is highlighted in said depiction. In order to improve the depiction of the route information, driving speeds are sensed while traveling, and that the highlighting of the segment traveled is carried out as a function of the sensed driving speeds.

### BACKGROUND OF THE INVENTION

1. Field of the Invention

The present invention relates to a method for depicting route information for a navigation system, in which a graphical depiction of a digitized map is displayed on a display, and the already-traveled segment of a travel route is highlighted in said depiction. The invention further relates to a navigation system for carrying out said method.

2. Description of Related Art

Navigation systems for destination route guidance in human-driven vehicles of any kind, in particular in passenger cars, have for some time ceased to be a rarity, but instead are now becoming established as standard equipment especially in moderately priced and higher-end motor vehicles. With the wide distribution of navigation systems and their continuing development, the range of functions of these navigation systems is also increasing, as are the demands made by customers on these systems. A simple depiction of the destination route, or destination guidance by way of optical and/or acoustic instructions, is therefore no longer adequate nowadays to excite sufficient purchasing interest among users and potential customers.

In most hitherto usual navigation systems, the portion of the route traveled up to a specific vehicle position is simply erased from the map depiction on a display of the navigation system, i.e. no longer displayed once the corresponding position has been passed.

Some new navigation systems that are presently being introduced to the market have, however, an additional function in which the depiction of the route already driven on and traveled is contrasted with the portion that still lies ahead, i.e. is yet to be driven. This enables the user to acquire, even with a quick glance, information about the segment traveled. With a suitably selected imaging scale, this can be the proportion of the total route constituted by the segment already traveled, or the curve profile of the segment that has been driven.

### BRIEF SUMMARY OF THE INVENTION

It is an object of the present invention to improve the depiction of route information for a navigation system, and in particular to display additional information in a manner that is quickly and easily graspable by the user.

In a method according to the present invention, provision is made that driving speeds are sensed as the segment is traveled, and the highlighting of the segment traveled is carried out as a function of the ascertained driving speeds. The functional feature of displaying the segment of the travel route that has already been driven is thereby usefully expanded, and this provides an additional gain in functionality in this connection for the user or vehicle driver. The utility of the navigation device is thereby increased.

In order to avoid distortions of the sensed sensor data, for example due to waiting times at a traffic light, a stop sign, or a “Yield” sign, in an advantageous embodiment of the method according to the present invention, standstill times are not taken into consideration in ascertaining the driving speeds.

The highlighting is preferably accomplished in multiple colors, each of which is allocated to a specific speed range. The color transitions between the various speed ranges can be graduated or, if the display enables it, can flow smoothly into one another.

Advantageously, the speed to be depicted is ascertained for each predetermined route section and is depicted with a corresponding marking. These can be, for example, marks having a circular peripheral shape, but also any other geometrical shape, for example triangles; or solid lines or splines are likewise conceivable.

In the case of a display with greatly reduced color depiction or for displays having only two colors, the marking is advantageously accomplished using multiple graphical symbols that are distinguishable from one another, each of which is allocated to a predetermined speed range. These can be, for example, solid circles or circles having a dot or the like at the center.

In an advantageous embodiment of the method according to the present invention, the driving speeds ascertained for depiction are compared with reference speeds stored in the digitized map, and in the event of a deviation beyond a defined tolerance range, this deviation is additionally depicted. This can be done, for example, by depicting the markings corresponding to the speeds at different sizes. An enlarged marking can indicate that the value exceeds the tolerance range, and a smaller marking that it is below the tolerance range. A modification of the contrast or color intensity, adapted to the deviation, is alternatively possible.

To make the ascertained speeds available for further functions, the ascertained driving speeds for the segment traveled are preferably stored.

Advantageously, average values for the route sections are calculated from the ascertained driving speeds in the course of traveling the respective route sections multiple times, and stored. This offers the possibility of creating driver-specific driving speed profiles.

In order also to expand application of the driver-specific driving speed profile to segments that have not yet been traveled, provision is advantageously made that for multiple route segments of specific road classes, the average values of the driving speeds are calculated and stored in class-specific fashion.

For a more realistic route calculation, the stored driving speeds are preferably taken into consideration.

Provision is preferably made that at least a sub-segment of the segment traveled is selected as a function of the ascertained driving speeds, and a route calculation is then carried out as a function of the selected sub-segments. This enables the selection of specific route sections that are to be avoided or detoured around in the context of a route calculation, for example construction areas or roads that are commonly overcrowded.

### BRIEF DESCRIPTION OF THE SEVERAL VIEWS OF THE DRAWINGS

FIG. 1 is a simplified schematic sketch of a navigation system according to the present invention.

FIG. 2 is a simplified schematic sketch of a depiction according to the present invention.

FIG. 3 shows the depiction of FIG. 2 with a sub-segment selected.

### DETAILED DESCRIPTION OF THE INVENTION

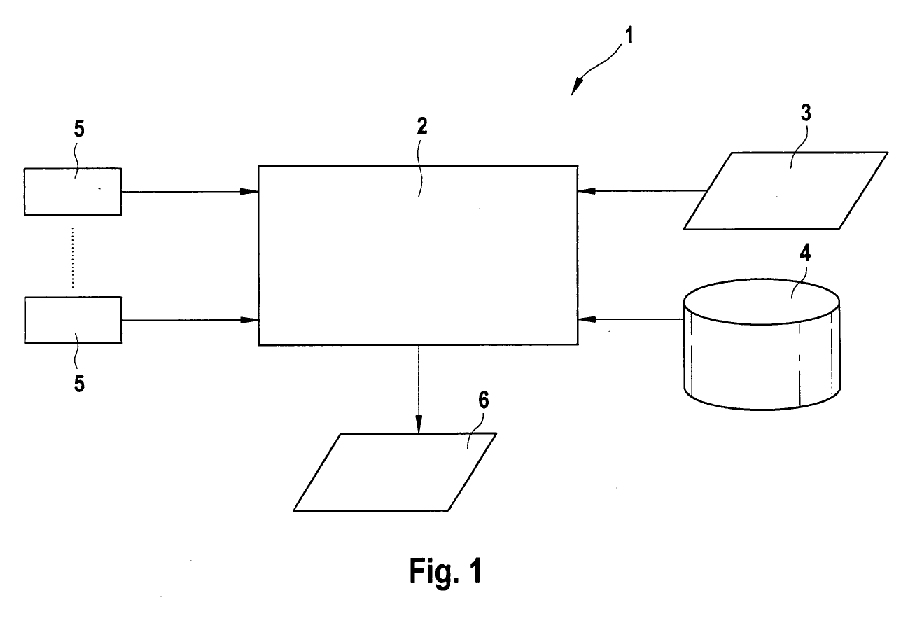

FIG. 1 depicts a navigation system 1 according to the present invention in schematically sketched fashion. The essential element of navigation system 1 is a data processing unit 2, usually a correspondingly suitable microprocessor, which receives various input data and processes them for output. The processing relates, for example, to a route calculation and to destination guidance in accordance with the calculated route. For this purpose data processing unit 2 receives, inter alia, data of an input device 3 with which the user can input, for example, information regarding the destination, parameters for route calculation, and/or a selection of specific sub-segments.

Navigation system 1 further has a memory device 4 that is connected to data processing unit 2. Memory device 4 that is depicted can have, for example, a single read/write memory or alternatively can have multiple, physically separate memories each for different memory functions. In the depiction of FIG. 1, memory device 4 is reproduced in simplified fashion as a single memory. The data of a digitized map of a road network are stored in memory device 4, and data processing unit 2 accesses said data in order to calculate the route, process the depiction data, and provide destination guidance. Further (for example, modifiable) data can additionally be stored in the memory device, containing information regarding speeds and/or user profiles, etc.

As depicted in FIG. 1, the navigation system has multiple speed sensors 5, for example odometers, which sense the speeds of the vehicle and then forward the sensed speed values to data processing unit 2. To allow retrieval of the sensed speeds at a later point in time, data processing unit 2 sends the values to memory device 4 for storage.

Lastly, data processing unit 2 is connected to an output device 6 with which the data regarding destination guidance and/or route information, processed by data processing unit 2 for depiction, are outputted to the user of navigation system 1. The navigation information can be outputted both visually/optically by way of a suitable display or monitor, or acoustically via loudspeakers.

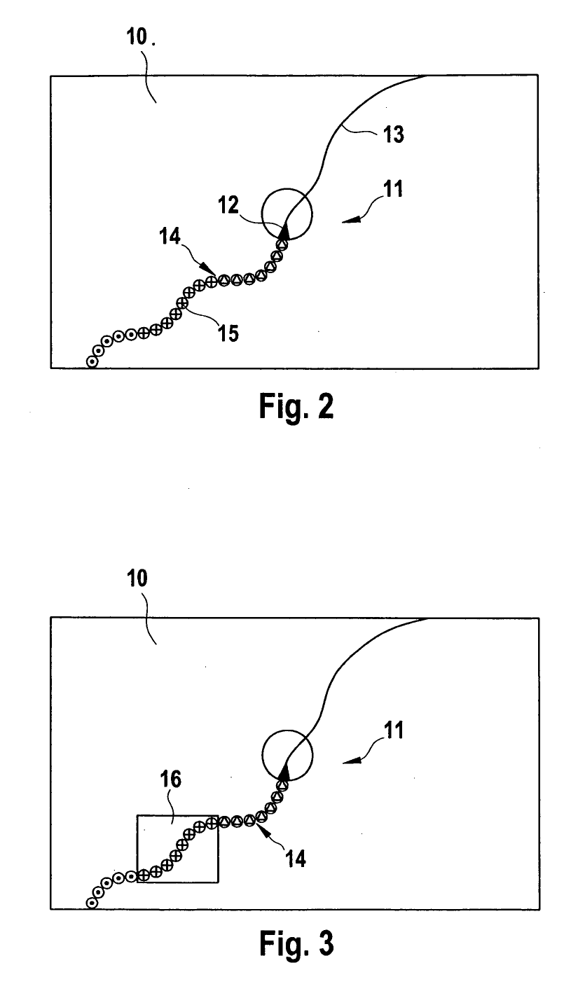

FIG. 2 shows a simplified depiction 10 of the route information that is displayed on a display or monitor of navigation system 1 of FIG. 1. The depiction 10 presented here by way of example shows a two-dimensional navigation map. The method according to the present invention can also, however, with no limitation as to function, be applied to oblique depictions (a so-called 2½-dimensional map depiction), or also to spatial or three-dimensional depictions.

Depiction 10 indicates a present vehicle position on a travel route 11 with the aid of a cursor 12 that, in addition to the position information, also reproduces a directional datum by way of the integrated arrow. For the sake of simplicity, only travel route 11 is reproduced in the depiction. The remainder of the communication route network, and the display of additional information such as urban areas, forests, bodies of water, and/or points of interest (POIs), are omitted here for reasons of clarity.

Travel route 11 is divided by cursor 12 into a first section 13 of the segment of travel route 11 yet to be driven, and a second section 14 of the segment of travel route 11 already traveled. Second section 14 of the route traveled is depicted here in highlighted fashion. This is accomplished, in the depiction of FIG. 2, using round markings 15 that are disposed serially along second section 14 of travel route 11.

The position of markings 15 can be established according to a defined algorithm, for example equidistantly in consideration of the vehicle speed and the selected map scale. The possibility exists here of ascertaining the speed that is to be depicted, for each marking that is provided, as an average speed of all the speed values sensed for that route section, or also ascertaining the maximum speed sensed in each case.

The additional information regarding the driving speed in a specific route section is implemented by visualization using different symbols within the circular markings. These symbols can be, for example, a dot, a cross, an X, and/or shadings of various orientations and densities. This additional information can thereby be offered to the user, in a two-color depiction, in a simple manner that can be easily and quickly understood.

If a multi-color monitor is available for depiction, as is often the case with present-day navigation systems, the additional information regarding the driving speed in a specific route section can also advantageously be provided using different colors. When a suitable color scheme is used in consideration of the map colors that are used, this thus enables the simplest possible readability of the speed information. For example, four speed ranges can be selected using different colors. Speeds between 30 and 50 km/h can be depicted in yellow, speeds between 50 and 80 km/h in green, speeds between 80 and 120 km/h in blue, and speeds below 30 km/h in red.

Any other color scheme is of course also conceivable. Usefully, the speed regions for the color scheme can be based on the speed limits provided in legislation, or on maximum speeds permissible by law.

With a multi-color depiction, circular symbols 15 previously described with reference to FIG. 2 can additionally be used, these now additionally being depicted in appropriate colors. An alternative possibility is to depict the markings as solid colored circles. Also possible, however, is a depiction in which a solid line is colored in accordance with the speed ranges. The transition between two speed ranges can occur abruptly or continuously with the aid of color gradients, and depends on the multi-color display capability of the monitor and its underlying graphical system.

The utility of the invention presented here is increased by the possibility of using the additionally depicted speed information for a destination route calculation taking place at a later point in time in accordance with modified user stipulations. By skilful configuration of the interface between the driver and navigation system 1 (human-machine interface, HMI), it is even possible for the driver to introduce the previously utilized route information component into a new destination route calculation as he or she wishes and requires. He or she thus has the ability to adjust the extent to which new information is reused.

This is described below with reference to FIG. 3. One possible application for this is, for example, the return journey from B to A when the route from A to B has already been traveled and the speed values sensed in that context have been stored in a manner allocated to the route sections.

Taking into account the same route calculation parameters, for example “fastest route,” “shortest route,” etc., and if the routes have no one-way roads, it is probable that in principle the same route will be calculated by navigation system 1 for the return journey, except in the opposite direction of travel. In the specific instance, however, it may be the case that a traffic impediment exists on a specific route section, with the result that the sensed driving speed is greatly reduced in this route section. The traffic impediment can be, for example, a construction area or a road that is usually overcrowded. The driver would then like to take a favorable detour around this traffic impediment on the return journey, or exclude it from the destination route calculation. To ensure that traffic impediments that exist in only one direction of travel (e.g. only for the outward journey) are not considered for the return journey, a manual input of such information can, optionally, additionally be provided for.

By way of a suitable mechanism for selecting a corresponding region on route section 14 (already originally traveled from A to B) of travel route 11, the driver has the capability, with the aid of the route information described above with reference to FIG. 2, of selecting a specific route section 16, as reproduced in FIG. 3. This selection can take place using standard mechanisms for selection on a navigation map, for example by inscribing a rectangle using suitable input elements or by a drawing a region with one's finger on a touchscreen unit. Assistance can be provided by the fact that in simple fashion, the boundaries of the selected region coincide with a transition into a different speed region, and the mechanism defines regions bounded in that fashion.

1-12. (canceled)

13. A method for graphically depicting route information on a navigation system of a vehicle, comprising:
ascertaining the driving speed of the vehicle as each segment of a travel route of the vehicle is traveled by the vehicle; and
displaying a graphical depiction of a digitized map on a display, wherein already-traveled segments of the travel route of the vehicle are shown in highlighted fashion in said depiction;
wherein a characteristic feature of the highlighting of each traveled segment is dependent on the ascertained driving speed associated with the traveled segment.

14. The method as recited in claim 13, wherein standstill times for the vehicle are not taken into consideration in ascertaining the driving speeds.

15. The method as recited in claim 14, wherein the highlighting of each traveled segment is accomplished using one of multiple different colors, each color being allocated to a predetermined speed range.

16. The method as recited in claim 13, wherein the highlighting of each traveled segment is accomplished using one of multiple different graphical symbols, each symbol being allocated to a predetermined speed range.

17. The method as recited in claim 14, wherein the highlighting of each traveled segment is accomplished using one of multiple different graphical symbols, each symbol being allocated to a predetermined speed range.

18. The method as recited in claim 13, wherein the ascertain driving speed for each traveled segment is compared with a stored corresponding reference speed, and if the ascertained driving speed deviates from the reference speed by more than a specified tolerance amount, the deviation is additionally depicted.

19. The method as recited in claim 18, wherein the ascertained driving speeds for the traveled segments are stored.

20. The method as recited in claim 19, wherein an average driving speed for a traveled route segment is calculated from the ascertained driving speeds obtained from multiple travels over the traveled route segment, and wherein the average driving speed is stored.

21. The method as recited in claim 19, wherein an average driving speed for multiple traveled route segments of a specific road class is ascertained from the ascertained driving speeds corresponding to the multiple traveled route segments, and wherein the average driving speed is stored in road-class-specific fashion.

22. The method as recited in claim 21, wherein the stored average driving speed is taken into consideration for a route calculation.

23. The method as recited in claim 15, wherein at least a sub-portion of the already-traveled segments of the travel route is selected as a function of the ascertained driving speeds, and a route calculation is carried out as a function of the selected sub-portion.

24. A navigation system for graphically depicting route information on a navigation system of a vehicle, comprising:
a speed calculation unit configured to ascertain the driving speed of the vehicle as each segment of a travel route of the vehicle is traveled by the vehicle; and
a display configured to provide a graphical depiction of a digitized map on a display, wherein already-traveled segments of the travel route of the vehicle are shown in highlighted fashion in said depiction;
wherein a characteristic feature of the highlighting of each traveled segment is dependent on the ascertained driving speed associated with the traveled segment.
